(19) United States
(12) Patent Application Publication
(10) Pub. No.: US 2015/0233340 A1
(43) Pub. Date: Aug. 20, 2015

(54) SEASHORE FACILITY FOR GENERATING ENERGY FROM SEA WAVES

(71) Applicants: Yechezkel LEVI, Jerusalem (IL); Mordechai Levi, Jerusalem (IL); Elior Levi, Jerusalem (IL); Tamir Levi, Jerusalem (IL)

(72) Inventors: Yechezkel LEVI, Jerusalem (IL); Mordechai Levi, Jerusalem (IL); Elior Levi, Jerusalem (IL); Tamir Levi, Jerusalem (IL)

(21) Appl. No.: 14/507,853

(22) Filed: Oct. 7, 2014

Related U.S. Application Data
(60) Provisional application No. 61/940,434, filed on Feb. 16, 2014.

(51) Int. Cl. F03B 13/14; F03B 13/22; E02B 3/00

(52) U.S. Cl. CPC F03B 13/147; E02B 3/00; F03B 13/22

(57) ABSTRACT

A seashore wave energy converting facility (10), comprising: an ascending ramp (12), being a sloped ramp installed at seashore line such that a lowered end thereof (12a) is immersed in the sea while an elevated end thereof (12b) is located above the sea level; a descending ramp (14), being a sloped ramp having a opposite slope with regard to the ascending ramp (12), the descending ramp being connected continuously by an elevated end thereof to the elevated end (12b) of the ascending ramp (12); a turbine (20) located under a lower edge of the at least one additional descending ramp (14); and a construction (18) for placing the facility (10) at seashore line; thereby enabling installation of the wave energy converting facility (10) at a seashore. The sea water may be directed to a spiral ditch, wherein the turbine is disposed, thereby increasing the power generation efficiency.

The current application claims the benefit of U.S. Provisional Patent Application No. 61/940,434, filed 16 Feb. 2014, incorporated herein by reference.

### TECHNICAL FIELD

The present invention relates to the field of hydropower facilities. More particularly, the present invention relates to a seashore facility for generating energy from sea waves.

### BACKGROUND ART

“Hydro-power or water power is power derived from the energy of falling water and running water, which may be harnessed for useful purposes. Since ancient times, hydro-power has been used for irrigation and the operation of various mechanical devices, such as watermills, sawmills, textile mills, dock cranes, domestic lifts, power houses and paint making.”

Since the early 20th century, the term has been used almost exclusively in conjunction with the modern development of hydro-electric power, which allowed use of distant energy sources.” (From Wikipedia, the free encyclopedia)

“Wave Dragon”, http://en.wikipedia.org/wiki/Wave_Dragon, is considered by the Applicant as closest prior art. It is a floating slack-moored energy converter of the overtopping type, located in the northern Denmark.

It consists of two wave reflectors that direct the waves towards a ramp. The water that reaches the end of the ramp is directed to a large reservoir that temporarily stores it. The reservoir is maintained above sea level. The water leaves the reservoir through hydro turbines, which generate electricity.

In order to operate, one end of the ramp must be located at sea level, while the other end thereof must be located above the sea level. However, since the sea level changes during the day as a result of tides, such a facility must deal with the tides phenomena.

Wave Dragon solves this problem by floating the facility, and mooring it to the seabed. In this way, the ramp is positioned at a constant distance from the sea level.

However, placing the facility at the sea results in obstacles such as transportation of the generated energy to the mainland, maintenance of the facility, and so on.

As such, there is a long felt need for a seashore facility for generating energy from sea waves.

Other objects and advantages of the invention will become apparent as the description proceeds.

### SUMMARY OF THE INVENTION

The terms “ascending ramp” and “descending ramps” are defined herein with reference to a water movement. More specifically, the term “ascending ramp” refers herein to a sloped ramp in which moving water from the sea to the shore ascends thereon, while the term “descending ramp” refers herein to a sloped ramp in which moving water from the sea to the shore descends therefrom.

A seashore wave energy converting facility (10), comprising:
an ascending ramp (12), being a sloped ramp installed at seashore line such that a lowered end thereof (12a) is immersed in the sea while an elevated end thereof (12b) is located above the sea level;
a descending ramp (14), being a sloped ramp having a opposite slope with regard to the ascending ramp (12), the descending ramp being connected continuously by an elevated end thereof to the elevated end (12b) of the ascending ramp (12);
a turbine (20) located under a lower edge of the at least one additional descending ramp (14); and
a construction (18) for placing the facility (10) at seashore line;
thereby enabling installation of the wave energy converting facility (10) at a seashore.

The facility (10) may further comprise: at least one additional descending ramp (14a), located lower than of the first descending ramp (14) and being connected continuously to a corresponding opening (36a) in the ascending ramp (12), for allowing sea water (30) ascending on the ascending ramp (12) to pass through the opening (36a) to the at least one additional descending ramp (14a).

The facility (10) may further comprise: a water reservoir (22) to which each of the descending ramps (14, 14a) leads, for accumulating sea water (30), thereby allowing generating energy on demand.

The facility (10) may further comprise: a water reservoir (22) to which the ascending ramp (12) leads, for accumulating sea water (30), thereby allowing generating energy on demand.

The facility (10) may further comprise: openings (38) for allowing returning water from the shore to the sea to pass therethrough.

According to one embodiment of the invention, the ascending and descending ramps further comprise side walls (34), thereby diminishing spillage of flowing sea water from the ramps, resulting with increasing an efficiency of the facility (10).

According to one embodiment of the invention, the ascending and descending ramps have a wavy profile, thereby diminishing spillage of flowing water therethrough, resulting with increasing an efficiency of the facility (10).

According to one embodiment of the invention, the ascending and descending ramps have sectors (16) divided by side walls (34), thereby diminishing spillage of flowing water therethrough, resulting with increasing an efficiency of the facility (10).

According to one embodiment of the invention, each of the descending ramps (14, 14a) has dedicated turbine(s) (20), each located under the lower end of its descending ramp (14, 14a).

The facility (10) according to claim 1, may further comprise:
an elevated sea water reservoir (50);
a pump (52) for lifting the sea water to the elevated reservoir (50); and
a spigot (not illustrated), for enabling and disabling the elevated sea water to flow downwards on a turbine,
thereby allowing generating energy from the facility (10) on demand.

The facility (10) may further comprise covers for covering the openings (36a, 36b, . . . ), thereby allowing diverting waves, for enabling carrying out maintenance of the facility.

According to one embodiment of the invention, the descending ramps is comprised of at least one pipe, thereby diminishing spillage of flowing sea water from the ramp, resulting with increasing an efficiency of the facility (10).

According to one embodiment of the invention, the descending ramps is comprised of at least one pipe, thereby diminishing spillage of flowing sea water from the ramps, resulting with increasing an efficiency of the facility (10).

The facility (10) may further comprise: a spiral ditch (54) into which sea water entering to the facility are directed, thereby generating a whirlpool; wherein the turbine (20) is disposed in a center of the whirlpool; thereby applying force of all vanes of the turbine, resulting with increased power generating efficiency.

According to one embodiment of the invention, the reservoir (22) is in an upside-down conic form, thereby generating a whirlpool. The turbine (20) is disposed in a center of the whirlpool, thereby applying force of all vanes of the turbine, resulting with increased power generating efficiency.

According to one embodiment of the invention, the seashore wave energy converting facility (10) further comprises: apertures (58) in said a descending ramp (14); and corresponding covers (60); thereby allowing diverting waves, for enabling carrying out maintenance of said turbines.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a cross-section which schematically illustrates an offshore facility for generating energy from sea waves, according to the prior art.

FIG. 2 is a perspective view of a seashore facility for generating energy from sea waves, according to one embodiment of the invention. FIG. 2 also defines a cross-section A-A.

FIG. 3 is a schematic drawing illustrating the result thereof.

FIG. 4 illustrates the sea water course in the facility.

FIG. 5 is a perspective view of a seashore facility for generating energy from sea waves, according to a further embodiment of the invention.

FIG. 6 is a top view of a segment of the embodiment of FIG. 5.

FIG. 7 pictorially illustrates a further embodiment of the invention.

FIG. 8 is a side view of the embodiment illustrated in FIG. 3, according to a further embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

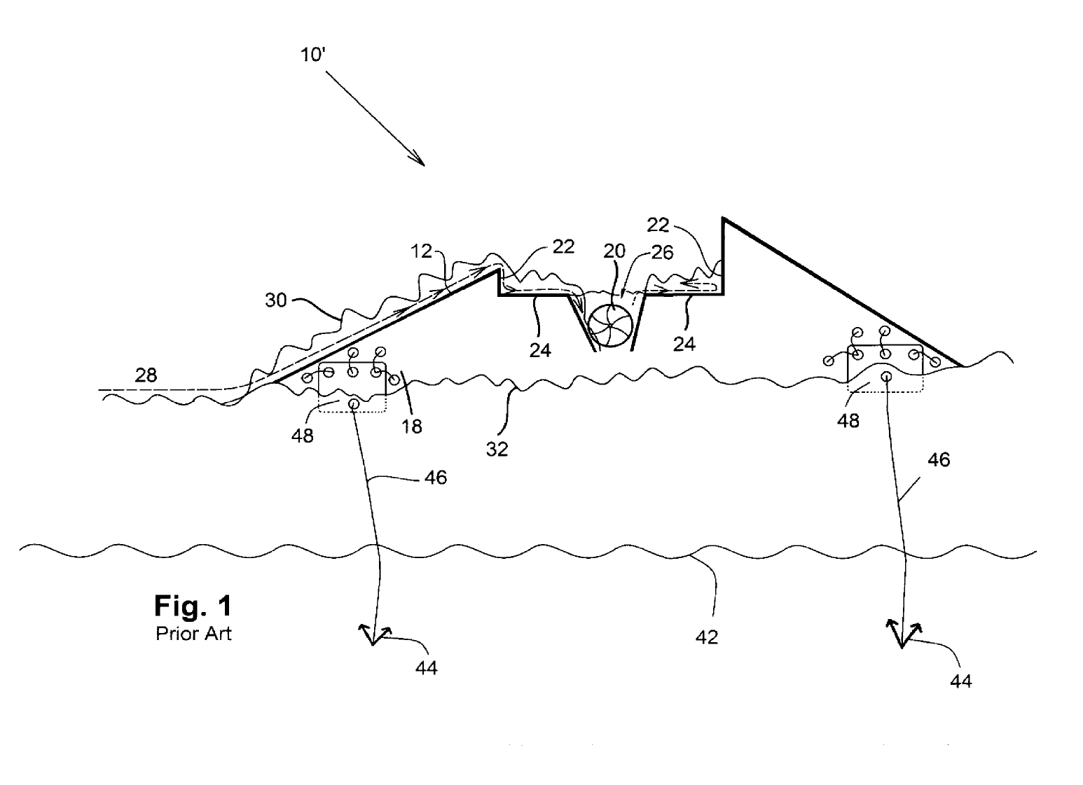

FIG. 1 is a cross-section which schematically illustrates an offshore facility for generating energy from sea waves, according to the prior art, according to the prior art.

The facility, which is marked herein by reference numeral 10′, comprises a reservoir 22 for temporary storing sea water. The bottom thereof is marked by numeral 24. The bottom 24 of the reservoir is located above the sea level 32.

The facility also comprises an ascending ramp 12 in which the upper end thereof is located at the top of the walls of reservoir 22, and the lower end thereof is immersed in the sea.

Reference numeral 30 denotes sea waves, and reference numeral 28 denotes the moving direction of the sea waves. As the waves' motion 28 is horizontal, the sea water ascends the sloped ramp 12 as a result of the inertia of the waves, and then falls into reservoir 22, where it is temporarily stored.

At the bottom 24 of the reservoir is located an outlet 26, through which the water of the reservoir exits the reservoir.

In the water path from the outlet 26 of the reservoir is located a turbine 20, which is rotated by the passing water, thereby generating electric power.

The facility floats on floats 48, and is moored to the seabed by anchors 44 and mooring cable 46.

As mentioned above, placing the facility in the high seas results in obstacles such as transportation of the generated energy to the mainland, maintenance of the facility, and so on.

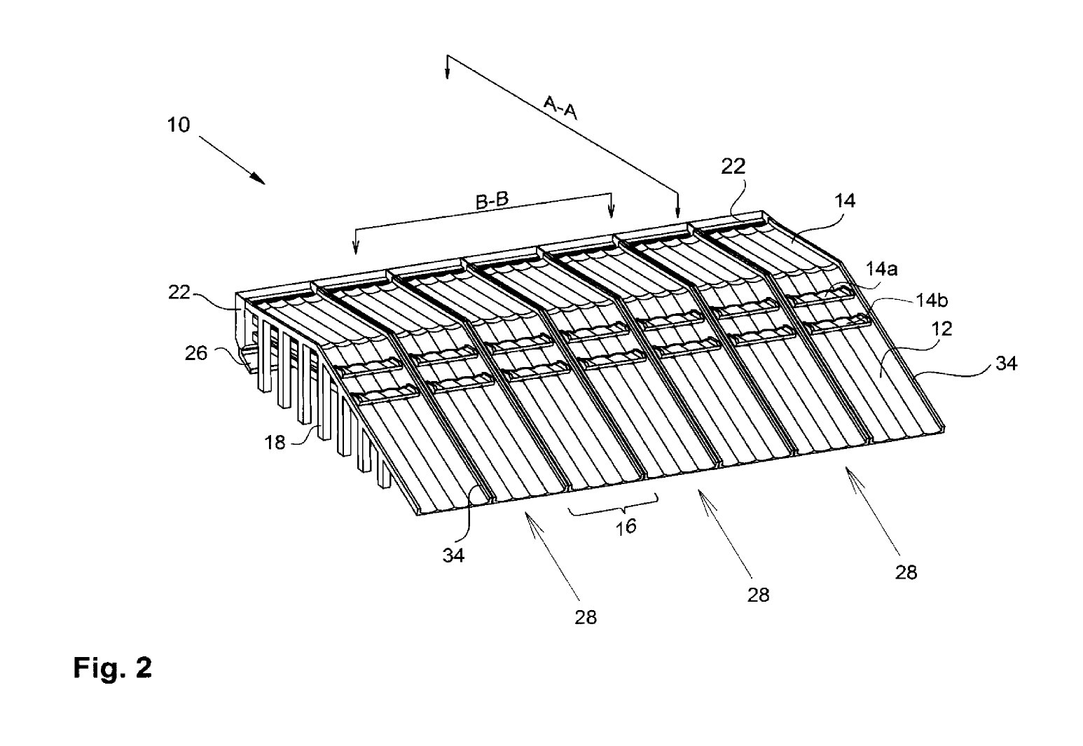

FIG. 2 is a perspective view of a seashore facility for generating energy from sea waves, according to one embodiment of the invention. FIG. 2 also defines a cross-section A-A.

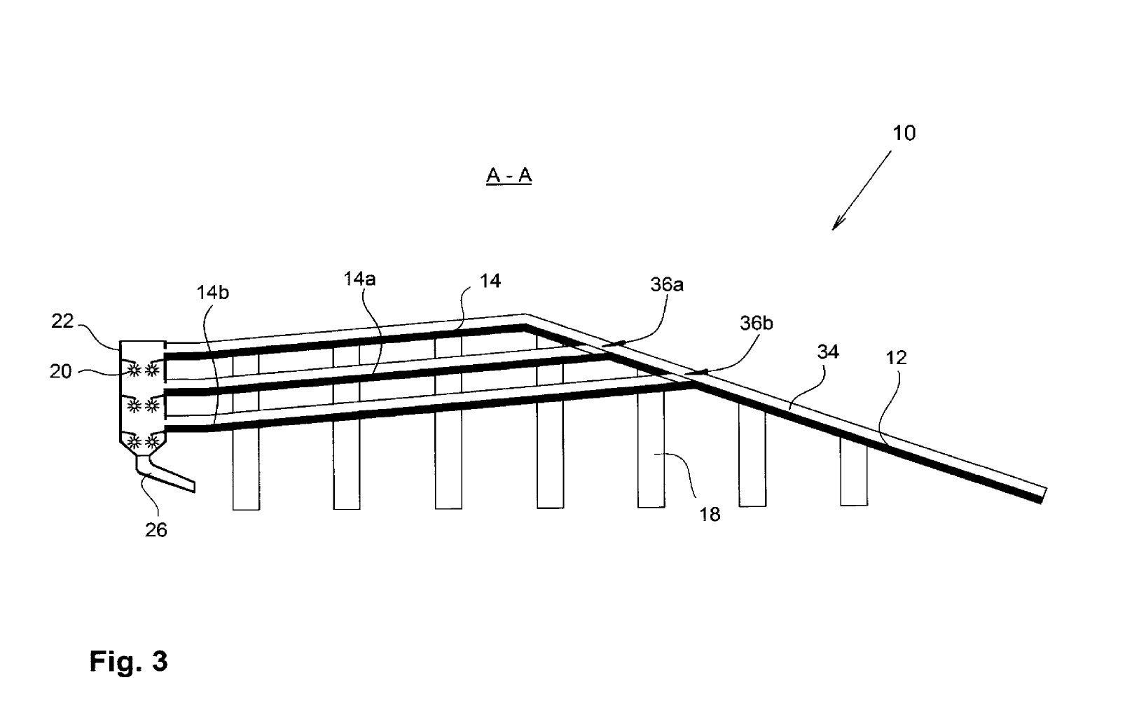

FIG. 3 is a schematic drawing illustrating the result thereof.

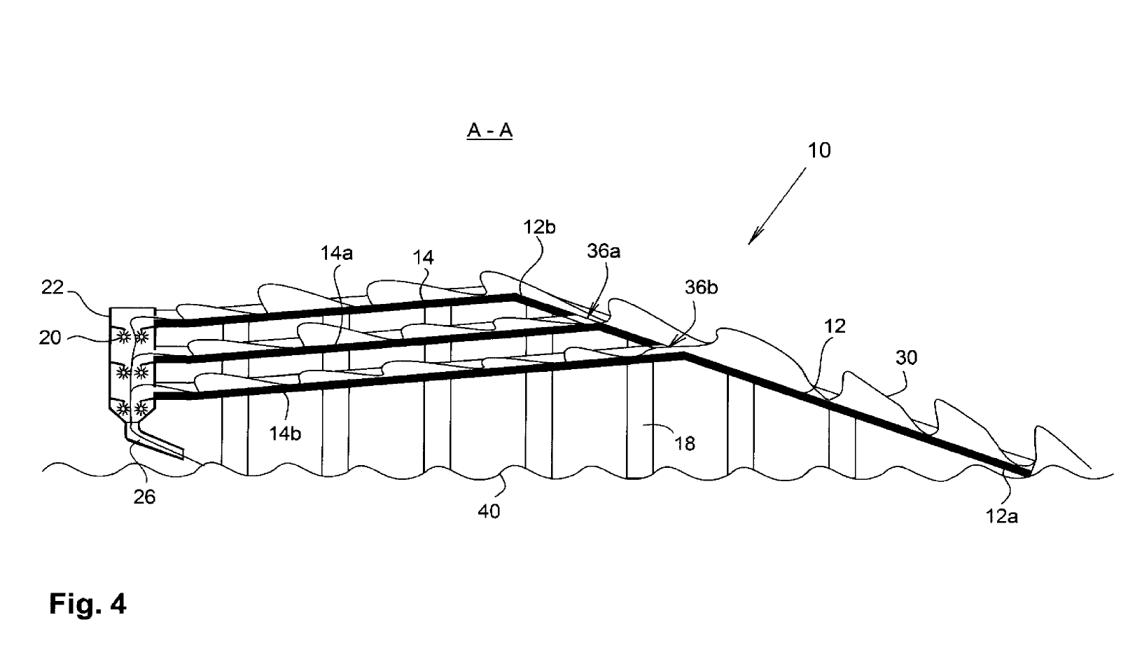

FIG. 4 illustrates the sea water course in the facility.

It should be noted that FIGS. 3 and 4 are not true results of cross-section A-A defined in FIG. 2, but schematic drawings thereof.

The seashore facility for generating energy from sea waves, which is marked herein by reference numeral 10, stands on pillars 18 located at a shore.

The facility comprises an ascending ramp 12. The top thereof, 12b of ramp 12, is connected to a descending ramp 14.

One end 12a of the ramp is located at the shore, while the other end 12b is located above the sea level. Thus, water flow (waves) 30 from the sea ascends on ramp 12, and after reaching to its peak 12b, it descends along ramp 14.

Under the upper end of the descending ramp 14 is located a reservoir 22, comprising an outlet 26 at the bottom thereof.

In the water path from the reservoir towards its outlet 26 is located a turbine 20. As the water falls, it rotates turbine 20, thereby generating electric power.

The facility comprises additional descending ramps 14a and 14b, connected to the ascending ramp 12. In order to allow the water from ramp 12 to reach the additional descending ramps 14a and 14b, ramp 12 comprises openings 36a and 36b.

The additional ramps allow utilizing water of different height levels. When the water level is “low”, only the lower descending ramps are utilized, and when the water level is “high”, the upper descending ramps are utilized as well.

This solution allows utilizing waves' energy seashore, thereby overcoming the obstacles of facilities such as Wave Dragon. Thus, as facility 10 is installed seashore, it does not face the obstacle of transporting the generated energy to the mainland. In addition, as facility 10 resides on the shore, its maintenance is easier in comparison to that of Wave Dragon and the like.

As per FIG. 2, when sectioning the facility as defined by cross-section B-B, the form is wavy. This structure allows diminishing the water spillage while the water is being directed towards the opening of the reservoir 22.

Furthermore, the ramp is divided by walls 34, thereby generating sectors 16 for the same purpose (diminishing spillage).

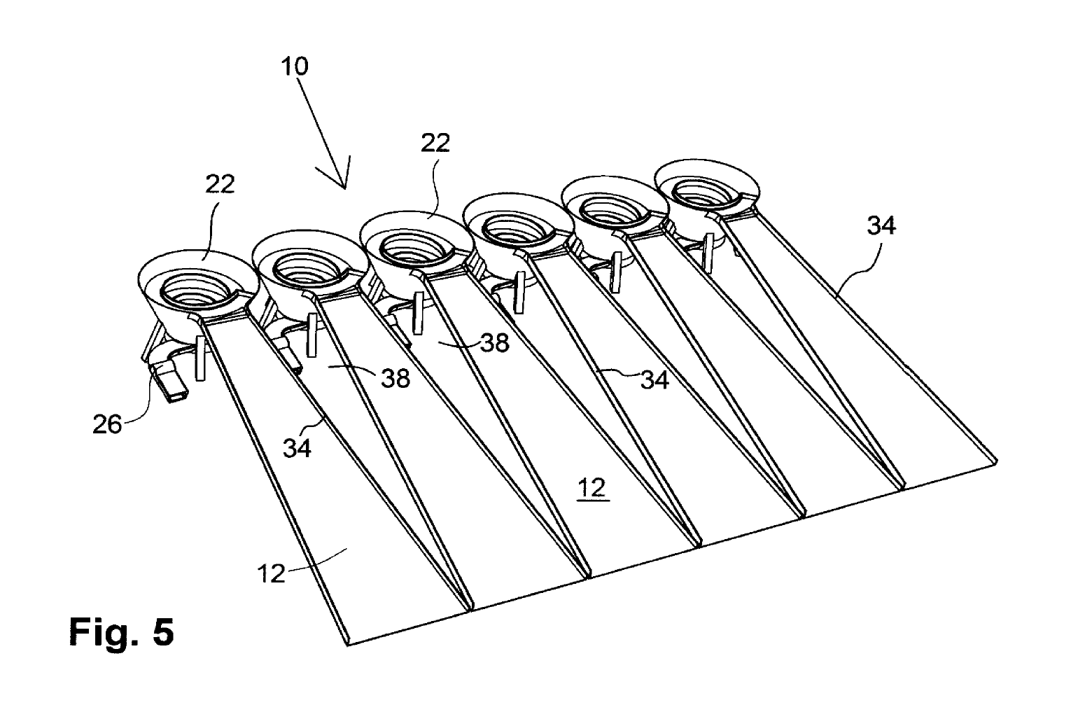

FIG. 5 is a perspective view of a seashore facility for generating energy from sea waves, according to a further embodiment of the invention.

In the examples of FIGS. 2 to 4, the returning water from the shore to the sea meets facility 10, which blocks the water passage. The solution presented in FIG. 5 solves this obstacle.

The figure describes a plurality of ascending ramps 12, each in a trapezoid form. The trapezoid form generates openings 38 through which the returning water can pass from the shore back to the sea.

In FIG. 5, the facility 10 comprises six independent segments. It should be noted the number of segments is arbitrary. The segments may be connected to each other in order to generate a massive structure.

For the sake of brevity, the descending ramps are not illustrated in FIG. 5.

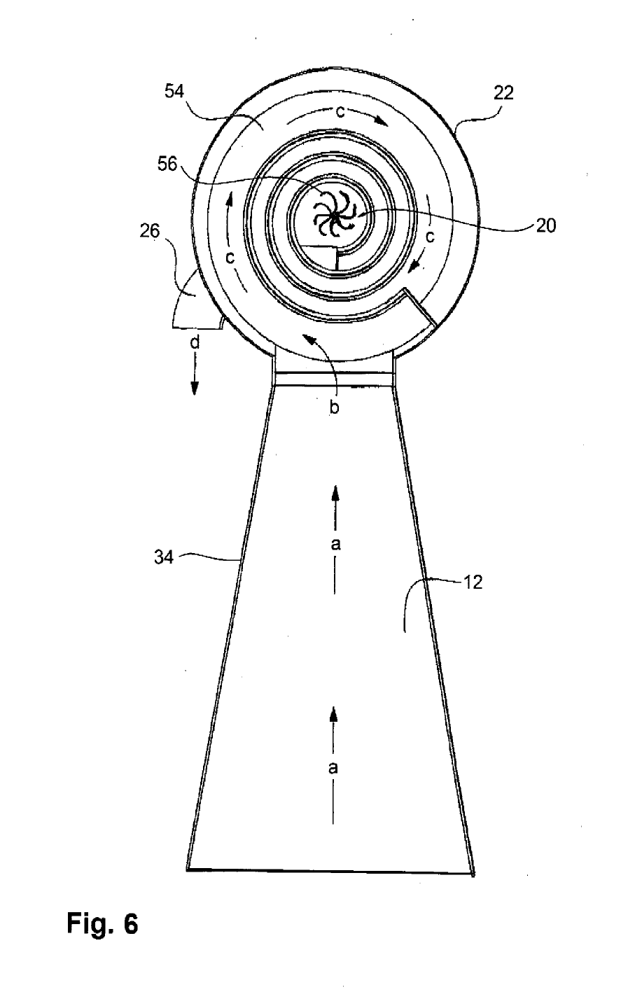

FIG. 6 is a top view of a segment of the embodiment illustrated in FIG. 5.

The segment comprises a spiral ditch 50, which causes the water that enters into the ditch to spin, resulting in creating a water whirlpool. The turbine 20 is disposed in the center of the whirlpool, thereby rotating.

As the turbine is disposed at the center of the whirlpool, the spinning water applies force on all the vanes 56 of turbine 20 simultaneously, thereby increasing the efficiency of the system. For comparison, water that falls on a turbine such as in FIG. 4 applies force simultaneously only on a part of the vanes of the turbine, but not all the vanes as in this embodiment.

The arrows of FIG. 6 describe the water movement on the segment facility.

Arrow “a” demonstrates the movement of the water that ascends on ramp 12 due to the inertia thereof; arrow “b” demonstrates the entrance of the water into the spiral ditch 54; arrow “c” demonstrates the spinning of the water in the spiral ditch; and arrow “d” demonstrates the exiting of the water from the facility through outlet 26.

It should be noted that in FIG. 5 the water reservoir 22 may be in an upside-down conic form. As a result of this form, the water path converges, thereby increasing the spinning speed of the water, thereby increasing the efficiency of the system.

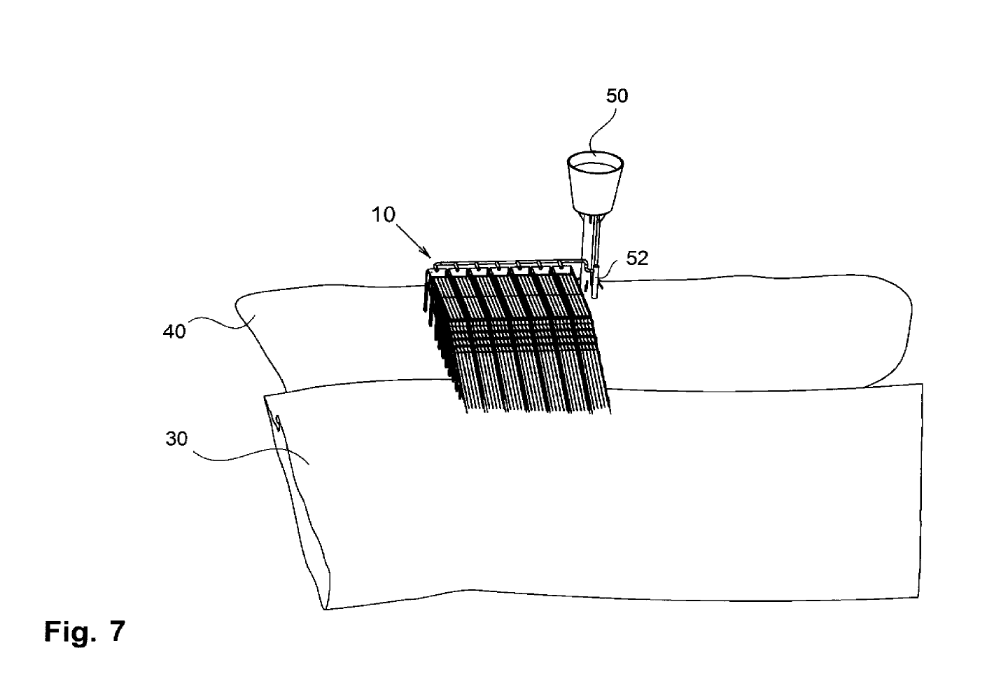

FIG. 7 pictorially illustrates a further embodiment of the invention.

The figure shows a seashore wave energy converting facility 10, an elevated sea water reservoir 50 and a pump 52.

The energy generated by facility 10 is used for pumping sea water from the sea, and putting the pumped water into the elevated reservoir 50. As such, the elevated sea water can be poured out of the lifted reservoir, and operating a turbine for generating energy. Thus, the stored energy can be used on demand, i.e., not necessarily upon generating of the energy from sea water.

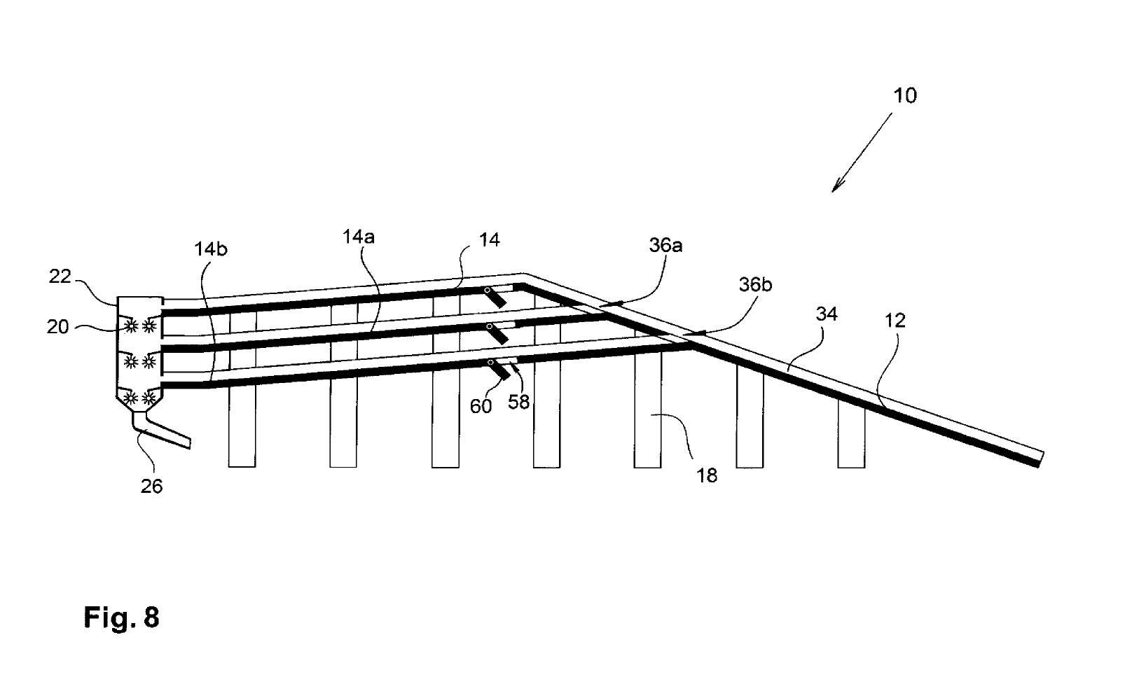

FIG. 8 is a side view of the embodiment illustrated in FIG. 3, according to a further embodiment of the invention.

In this embodiment numeral 58 denotes an aperture 58, and numeral 60 denotes a closure of aperture 58.

When the turbines need maintenance, the reservoirs 22 must first to be emptied. Additionally, it must be ensured that they do not refill. This can be carried out by opening covers 60 in order to enable the water to flow down through aperture 58 rather than reaching the reservoir.

In the figures and/or description herein, the following reference numerals (Reference Signs List) have been mentioned:
numeral 10 denotes a seashore facility for generating energy from sea waves, according to one embodiment of the invention;
numeral 10′ denotes an offshore facility for generating energy from sea waves, according to the prior art;
numeral 12 denotes an ascending ramp (which may be embodied also as pipes and the like);
numeral 12a denotes an end of the ascending ramp 12 which is located at the shore;
numeral 12b denotes an end of the ascending ramp 12 which is located above the sea level;
each of numerals 14, 14a and 14b denotes a descending ramp;
numeral 16 denotes a sector of said ascending ramp;
numeral 18 denotes a pillar;
numeral 20 denotes a turbine;
numeral 22 denotes a water reservoir;
numeral 24 denotes a bottom of reservoir 22;
numeral 26 denotes an outlet from reservoir 22;
numeral 28 denotes the moving direction of the sea waves;
numeral 30 denotes sea waves/water;
numeral 32 denotes the sea level;
numeral 34 denotes walls/side walls of an ascending or descending ramp;
each of numerals 36a and 36b denotes an opening in ascending ramp 12 through which sea water reaches a descending ramp 14a and 14b, respectively;
numeral 38 denotes openings between adjacent ascending ramps through which returning sea water can pass;
numeral 40 denotes a shore;
numeral 42 denotes the seabed;
numeral 44 denotes an anchor;
numeral 46 denotes a mooring cable;
numeral 48 denotes a float that floats facility 10′;
numeral 50 denotes a lifted water reservoir;
numeral 52 denotes a pump;
numeral 54 denotes a spiral ditch;
numeral 56 denotes the vanes of turbine 20;
numeral 58 denotes an aperture 58; and
numeral 60 denotes a closure of aperture 58.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A seashore wave energy converting facility (10), comprising:
an ascending ramp (12), being a sloped ramp installed at seashore line such that a lowered end thereof (12a) is immersed in the sea while an elevated end thereof (12b) is located above the sea level;
a descending ramp (14), being a sloped ramp having a opposite slope with regard to said ascending ramp (12), said descending ramp being connected continuously by an elevated end thereof to said elevated end (12b) of said ascending ramp (12);
a turbine (20) located under a lower edge of said at least one additional descending ramp (14); and
a construction (18) for placing said facility (10) at seashore line;
thereby enabling installation of said wave energy converting facility (10) at a seashore.

2. A seashore wave energy converting facility (10) according to claim 1, further comprising:
at least one additional descending ramp (14a), located lower than of said first descending ramp (14) and being connected continuously to a corresponding opening (36a) in said ascending ramp (12), for allowing sea water (30) ascending on said ascending ramp (12) to pass through said opening (36a) to said at least one additional descending ramp (14a).

3. A seashore wave energy converting facility (10) according to claim 2, further comprising:
a water reservoir (22) to which each of said descending ramps (14, 14a) leads, for accumulating sea water (30), thereby allowing generating energy on demand.

4. A seashore wave energy converting facility (10) according to claim 1, further comprising:
a water reservoir (22) to which said ascending ramp (12) leads, for accumulating sea water (30), thereby allowing generating energy on demand.

5. A seashore wave energy converting facility (10) according to claim 1, further comprising openings (38) for allowing returning water from the shore to the sea to pass therethrough.

6. A seashore wave energy converting facility (10) according to claim 1, wherein said ascending and descending ramps further comprise side walls (34), thereby diminishing spillage of flowing sea water from said ramps, resulting with increasing an efficiency of said facility (10).

7. A seashore wave energy converting facility (10) according to claim 1, wherein said ascending and descending ramps have a wavy profile, thereby diminishing spillage of flowing water therethrough, resulting with increasing an efficiency of said facility (10).

8. A seashore wave energy converting facility (10) according to claim 1, wherein said ascending and descending ramps have sectors (16) divided by side walls (34), thereby diminishing spillage of flowing water therethrough, resulting with increasing an efficiency of said facility (10).

9. A seashore wave energy converting facility (10) according to claim 2, wherein each of said descending ramps (14, 14a) has dedicated turbine(s) (20), each located under the lower end of its descending ramp (14, 14a).

10. A seashore wave energy converting facility (10) according to claim 1, further comprising:
an elevated sea water reservoir (50);
a pump (52) for lifting said sea water to said elevated reservoir (50); and
a spigot, for enabling and disabling the elevated sea water to flow downwards on a turbine,
thereby allowing generating energy from said facility (10) on demand.

11. A seashore wave energy converting facility (10) according to claim 1, further comprising covers for covering said openings (36a, 36b, . . . ), thereby allowing diverting waves, for enabling carrying out maintenance of said facility.

12. A seashore wave energy converting facility (10) according to claim 1, wherein said descending ramps is comprised of at least one pipe, thereby diminishing spillage of flowing sea water from said ramp, resulting with increasing an efficiency of said facility (10).

13. A seashore wave energy converting facility (10) according to claim 2, wherein said descending ramps is comprised of at least one pipe, thereby diminishing spillage of flowing sea water from said ramps, resulting with increasing an efficiency of said facility (10).

14. A seashore wave energy converting facility (10) according to claim 1, further comprising:
a spiral ditch (54) into which sea water entering to said facility are directed, thereby generating a whirlpool;
wherein said turbine (20) is disposed in a center of said whirlpool;
thereby applying force of all vanes of said turbine, resulting with increased power generating efficiency.

15. A seashore wave energy converting facility (10) according to claim 1, wherein:
said reservoir (22) is in an upside-down conic form, thereby generating a whirlpool; and
wherein said turbine (20) is disposed in a center of said whirlpool;
thereby applying force of all vanes of said turbine, resulting with increased power generating efficiency.

16. A seashore wave energy converting facility (10) according to claim 1, further comprising:
apertures (58) in said a descending ramp (14); and
corresponding covers (60);
thereby allowing diverting waves, for enabling carrying out maintenance of said turbines.
